(19) United States
(12) Patent Application Publication
(10) Pub. No.: US 2010/0106609 A1
(43) Pub. Date: Apr. 29, 2010

(54) INVENTORY ANALYSIS AND MERCHANDISING SYSTEM AND METHOD

(76) Inventors: Abe P. Sherman, South Lake Tahoe, CA (US); Mark I. Wolfson, Cherry Hill, NJ (US); Ellen Falcinelli, Napa, CA (US)

Correspondence Address: ADVANTIA LAW GROUP, 9035 SOUTH 1300 EAST, SUITE 200, SANDY, UT, 84094, US

(21) Appl. No.: 12/579,943

(22) Filed: Oct. 15, 2009

Related U.S. Application Data
(60) Provisional application No. 61/106,082, filed on Oct. 16, 2008.

(51) Int. Cl. G06Q 10/00; G06Q 30/00; G06F 17/30; G06F 15/16

(52) U.S. Cl. 705/21; 705/28; 709/218; 707/E17.014; 707/E17.044

(57) ABSTRACT

An analysis system for providing remote updated inventory management and merchandising data to a retailer. The analysis system includes a network module and a communication module configured to provide wireless communication over a network. The system also includes a translation module configured to translate data to a desired format. The translation module is in communication with a point-of-sale device of a retailer, wherein the translation module receives data directly from the point-of-sale device of the retailer. The analysis system also includes a data storage module configured to store data in a desired format. The system further includes a report generation module configured to generate dynamic reports therefrom. The analysis system includes a report interaction module configured to facilitate dynamic modification of reports. The system includes a data modification module configured to alter data stored in the data storage module.

### CROSS-REFERENCE TO RELATED APPLICATIONS

This invention claims priority, under 35 U.S.C. § 120, to the U.S. Provisional Patent Application No. 61/106,082 to Abe Sherman et al. filed on Oct. 16, 2008, which is incorporated by reference herein.

### BACKGROUND OF THE INVENTION

1. Field of the Invention

The present invention relates to merchandising systems and methods, specifically to an inventory analysis and merchandising system and methods.

2. Description of the Related Art

One of the challenges facing retailers today is managing and controlling inventory. Often, retailers will have too much cash tied up in aged or non-performing inventory. Further, it is common for retailers to have a difficult time keeping popular products in stock all of the time. More, it is nearly impossible to sift through the countless stacks of paper generated by point-of-sale systems to see what is really going on with a company's inventory. Accordingly, systems have been developed for improving inventory and sales management for retail stores.

In many cases, inventory and sales processes have become automated and managed by computer systems. Large databases hold a wealth of point-of-sale (“POS”) and inventory information. Some systems are configured to automatically reorder a product if inventory levels drop below a certain predetermined threshold. Users of such a system will try to guess what that predetermined threshold should be, in order to keep inventory on hand.

Other systems may provide methods of altering inventory information on a real-time basis as sales are made and as inventory shipments are received. Bar codes and RFID tags have provided rapid interfacing with such computer systems.

With this wealth of information, many retailers have become swamped with data, files, and numbers—too much information. Accordingly, retailers generally only use these systems to support processes and plans already familiar to them and they only receive a small measure of the benefit the data enables. Where further benefits are desired, a retailer may hire an analyst to help understand the river of data and suggest changes. Analysts are very expensive, since each system is different and appropriate time must be spent on “getting up to speed.” Since each system is different and each retailer is working at varying levels of performance, every analyst job is a customized process with generally unique results. Accordingly, taking proper advantage of the data is expensive and has unpredictable results.

Some improvements have been made in the field. Examples of such are described below, in their own words, and the supported teachings of each reference are incorporated by reference herein:

U.S. Publication No.: 2004/0049465 by Engler, Jeffery T. et al, discloses a method of generating custom reports based on point-of-sale data transferred between multiple remote computing devices and a central computing device includes generating point-of-sale data at multiple remote locations, transferring the point-of-sale data to a central computing device from multiple computing devices at the respective multiple remote locations, defining a custom report format, the custom report format specifying at least two of the multiple remote locations and specifying a date range, the date range and the at least two multiple remote locations being freely selectable by a user, generating a custom report using the custom report format, the custom report being based on point-of-sale data related to the specified remote locations and the specified date range, and communicating the custom report to a human being. A computer program embodied on a computer-readable medium for generating custom reports is also disclosed, as are subscription services, computer systems, graphical user interfaces and other features.

U.S. Publication No. 2004/0181454 by Manno, Michael, discloses a network or web-based point-of-sale (WPOS) system employs a store server and point-of-sale retailer computers that are connected over a store LAN or over the Internet to the server. The server provides all necessary operating drivers for cash drawer, scanners, and other point-of-sale peripherals via the web browser of the retailer computers. An instant kiosk retail solution can involve a remote computer terminal installed via the Internet, and will support peripheral POS devices. The web-based system permits management to obtain store performance reports remotely, and permits retail customers to schedule and reschedule appointments and delivery times. Servers at two or more store sites can communicate with one another and with a headquarters mainframe. The WPOS can be implemented as an integrated suite for collaboration between store locations.

U.S. Publication No. 2003/0115285 by Lee, Ti-Chin et al, discloses a Web-based inventory management information system is proposed, which allows a company's inventory management taskforce to browse via Internet for all inventory-related information, including the incoming plans of inter-company purchase order, direct shipment, and local supply, as well as the company's current and future inventory stock, sales orders, market forecast, and so on, for the purpose of allowing everyone on the company's inventory management taskforce to learn and be well-informed of such information quickly and conveniently via Internet. The proposed Web-based inventory management information system is characterized by the use of a Web server to serve up all the inventory-related information in an online manner through Internet, so that everyone on the company's inventory management taskforce can conveniently gain access to all the inventory-related information via Internet.

U.S. Pat. No. 6,633,851, issued to Engler et al., discloses a method of generating custom reports based on point-of-sale data transferred between multiple remote computing devices and a central computing device includes generating point-of-sale data at multiple remote locations, transferring the point-of-sale data to a central computing device from multiple computing devices at the respective multiple remote locations, defining a custom report format, the custom report format specifying at least two of the multiple remote locations and specifying a date range, the date range and the at least two multiple remote locations being freely selectable by a user, generating a custom report using the custom report format, the custom report being based on point-of-sale data related to the specified remote locations and the specified date range, and communicating the custom report to a human being. A computer program embodied on a computer-readable medium for generating custom reports is also disclosed, as are subscription services, computer systems, graphical user interfaces and other features.

U.S. Pat. No. 6,611,839, issued to Nwabueze, discloses a computer implemented method for acquiring and presenting data for business analysis, and a computer readable media having program instructions for enabling the same are provided. One exemplary method identifies a set of data sources to be accessed for a user, acquires raw data from the data sources, stores the raw data from the data sources to raw data type specific locations and verifies the integrity of the stored raw data. Next the acquired raw data is transferred to processed data type specific compartments. The transferring process further includes detecting the data type of each of the raw data type specific compartments and converting the raw data to a uniform data type. The processed data is then transferred to a temporary database where display rules are applied. A requested report is then presented to the retail customer.

The inventions heretofore known suffer from a number of disadvantages which include being difficult to use, failing to anticipate large inventory shifts, failing to solve the problems of slow moving merchandise, failing to provide sufficient information, failing to provide information in a format that is adaptable to the expertise of the user, being difficult to manage, being expensive, being ineffective, being inefficient, being limited in application, and being inaccurate.

What is needed is an inventory analysis and merchandising system and method that solves one or more of the problems described herein and/or one or more problems that may come to the attention of one skilled in the art upon becoming familiar with this specification.

### SUMMARY OF THE INVENTION

The present invention has been developed in response to the current state of the art, and in particular, in response to the problems and needs in the art that have not yet been fully solved by currently available inventory analysis and merchandising systems and methods. Accordingly, the present invention has been developed to provide an inventory analysis and merchandising system configured to effectively and efficiently gather, process, present, and amend information related to sales and inventory in a retail setting.

In one embodiment of the invention, there is an analysis system for providing remote updated inventory management and merchandising data to a retailer. The analysis system may include a network module configured to receive information over a network. The network module may include a communication module configured to provide wireless communication over the network. In addition, the system may also include a translation module in communication with the network module and configured to translate data to a desired format. The translation module may include an inventory module, wherein the inventory module may be configured to collect data from a retailer. The translation module may be in communication with a point-of-sale device of a retailer, wherein the translation module receives data directly from the point-of-sale device of the retailer.

The analysis system may also include a data storage module in communication with the network module and configured to store data in a desired format. The system may further include a report generation module in communication with the data storage module and configured to generate dynamic reports therefrom. The report generation module may include a filter module, wherein the filter module may be configured to filter data to a desired format or view. The report generation module may also include a sorting module. The sorting module may be configured to sort data to a desired format. The analysis system may further include a report interaction module in communication with the report generation module and configured to facilitate dynamic modification of reports. This may result in the data being both filterable and sortable in real-time, dramatically altering the views of the data based on the users thought process. The report interaction module may include a modification module, wherein the modification module may be configured to modify dynamic reports. Furthermore, the analysis system may also include a data modification module in communication with the report interaction module and configured to alter data stored in the data storage module. The system may further include a data transmission module in communication with the network module and configured to provide data over a network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of an inventory analysis and merchandising system in operational context, according to one embodiment of the invention;

FIG. 2 is a sequence diagram of an inventory analysis and merchandising system in operational context, according to one embodiment of the invention;

FIG. 3 is a flow chart of an inventory analysis and merchandising method, according to one embodiment of the invention;

FIG. 4 is a module diagram of a system module of an inventory analysis and merchandising system, according to one embodiment of the invention;

FIG. 5 is a network diagram of an inventory analysis and merchandising system, according to one embodiment of the invention;

FIG. 6 is a screenshot of a dynamic report of an inventory analysis and merchandising system, according to one embodiment of the invention;

FIG. 7 is a screenshot of a dynamic report of an inventory analysis and merchandising system, according to one embodiment of the invention; and

FIG. 8 is a screenshot of a dynamic report of an inventory analysis and merchandising system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a retailer-side scripting language, such as JavaScript, VBScript or the like,

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point-of-sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

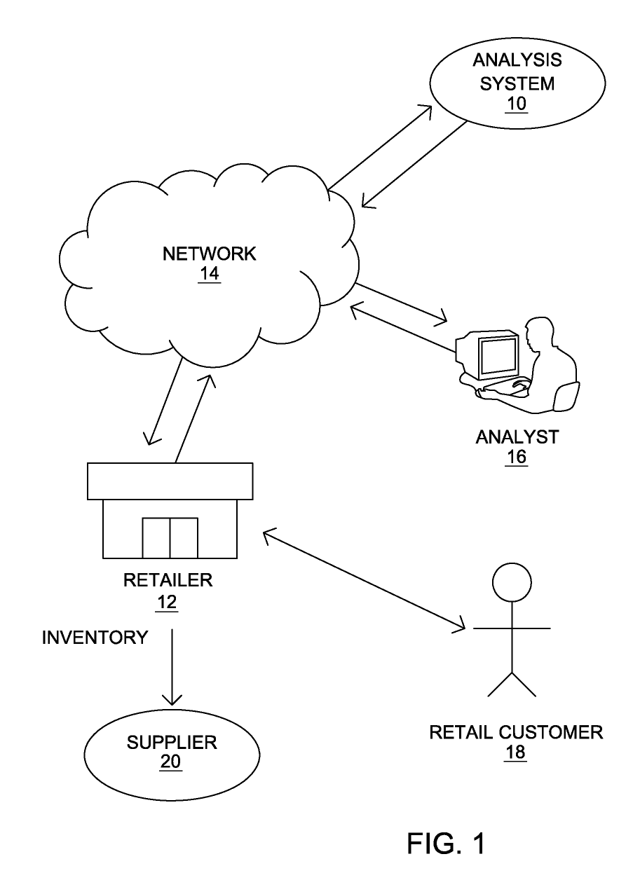

FIG. 1 is a network diagram of an analysis system 10 in operational context, according to one embodiment of the invention. There is shown an analysis system 10 in communication with a network 14 that is also in communication with a retailer 12 and an analyst 16. The retailer 12 receives merchandise from a supplier 20 and sells such to a retail customer 18. Transactions, shipments, and the like between supplier 20, retailer 12, and retail customer 18 generate inventory and merchandising data stored in information systems of the retailer 12. Such information may be provided over the network 14 to the analysis system 10 where it may be processed and made available to an analyst 16. The analyst 16 may review and/or further process the information provided by the analysis system 10 and may make recommendations and/or changes to the data that may be delivered to the retailer 12 and/or the analysis system 10.

The network 14 may include one or more communication systems and/or combinations thereof such as but limited to systems including: internet, intranet, wireless network, wifi networks, telephone networks, cellular networks, microwave communication systems, satellite networks, and the like.

Information received by the analysis system 10 may be processed in a manner than permits the analysis system 10 to generate dynamic reports. Dynamic reports are reports that permit user interaction and/or modification of the view displayed by the report and/or the data/metadata therein. Generally, reports provided in a inventory analysis context are flat reports that provide for zero interaction with a viewer other than exactly the interaction permitted by the view of the report. Non-limiting examples of dynamic report functionality include: reports that are sortable by one or more fields, such that selection of a field header in some manner causes the report to generate a new view wherein the data of the report is sorted according to the attribute associated with the field header; reports that are filterable, such that selection of a data characteristic may allow/disallow all record entries associated with such characteristic from being included in the displayed information; and reports that are capable of selectably organizing and displaying records according to a set of subfields within a data field such that a user may be enabled to “drill down” into the data to determine sources of effects or trends.

The illustrated analyst 16 may include hardware and/or software sufficient to view and interact with information provided by the analysis system 10. The analyst 16 may include a human analyst that may be an employee, contractor, or otherwise affiliated or not affiliated with any of the operators of the analysis system 10, the retailer 12, and/or the supplier 18, or any other party. The analyst 16 may include one or more modules configured to provide intelligent, scripted, or programmed data analysis, report interaction, and/or feedback with or without human interaction.

It is envisioned that the retailer 12 may include, but not limited to, a retail store and/or an information system associated with a retail store. Such a system may include a server, data storage hardware/software such as hard drives and database software (non-limiting example SQL by Microsoft Corp. Redmond Wash.). Furthermore, one skilled in the art would appreciate that the retailer 12 may include a plurality of retail establishments that may be location in different places and may have varying network presences.

In addition, it is envisioned that the supplier 20 may be, but not limited to, a plurality of suppliers of good/services, such as but not limited to manufacturers, distributors, resellers, brokers, buying groups, and the like.

In operation of one embodiment of the invention, a retail customer 18 purchases goods/services from a retailer 12. Upon receiving payment for the purchase of the goods/services, the retailer 12 receives sales data in regards to the retail customer 18. Sales data may be, but not limited to sale amount, sale date, type of purchase, location of purchase, retail customer data, etc. The retailer 12 sends inventory data and sales data through the network 14 to the analysis system 10. The analysis system 10 converts the data into dynamic inventory management reports. The reports are reviewed by an analyst 16 and the retailer 12, wherein the analyst 16 advises the retailer 12 on inventory management and merchandising strategy and/or specific actions. Because the reports are dynamic, the analyst is able to sort, filter, rearrange, combine, modify and/or otherwise manipulate the information into forms and formats that are suited to the particular circumstances presented by the data, the context in which it is presented, and the skill-set leveraged by the analyst. Advantageously, the analyst may be able to spot trends and issues not generally visible using standard flat reports that are lacking in interactivity. Further, the ability to modify the data, such as re-pricing, re-categorizing, or otherwise altering information in the dataset allows the analyst to help in ways not seen in the existing art. This process takes into consideration innumerable ways that individual users perceive data and encourages the user to become interactive with their data, rather than relying on static reporting as is found in existing art. As a non-limiting example, an analyst may thereby pre-implement one or more suggestions. Thereby the skills of the analyst may be more efficiently and effectively leveraged for the benefit of the retailer.

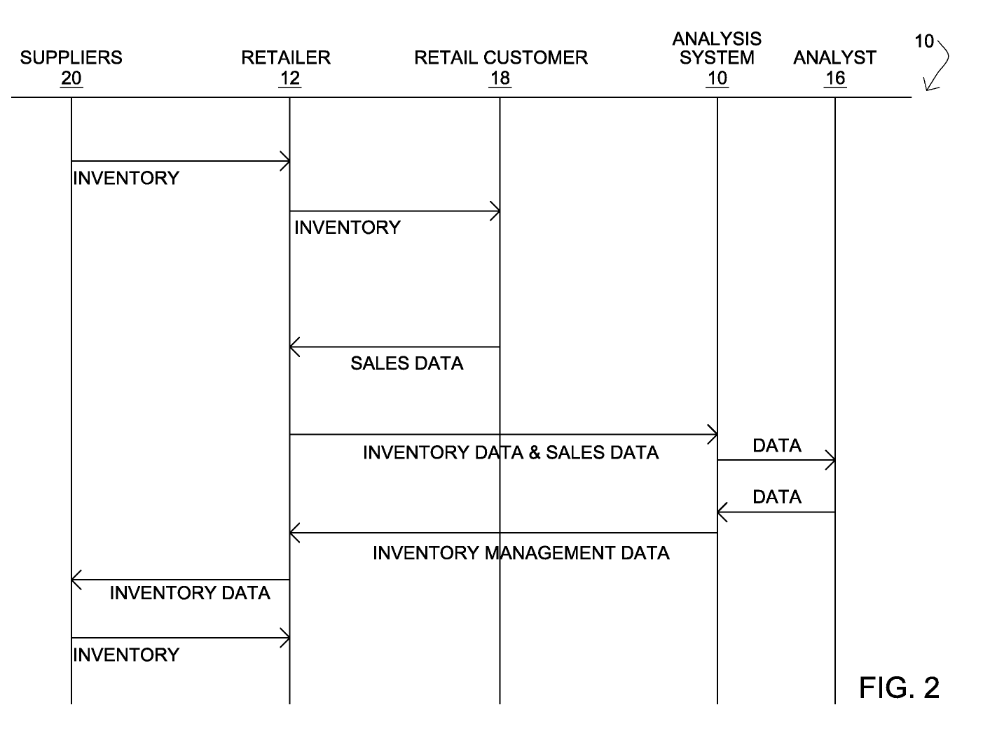

FIG. 2 is a sequence diagram of an analysis system 10 in operational context, according to one embodiment of the invention. The analysis system 10 includes a plurality of suppliers 20. The plurality of suppliers 20 send inventory to a retailer 12, then a retail customer 18 purchases the inventory from the retailer 12. The retailer 12, upon receiving payment for the inventory, also receives sales data from the retail customer 18 regarding the retail customer 18 and the products purchased. The retailer 12 then sends data, in regards to the inventory and the retail customer data received, to the analysis system 10. The analysis system 10 makes available data submitted by the retailer 12 in a dynamic dataset, thereby preparing or enabling preparation of a dynamic report, which is then provided to the analyst 16 for review, research, and/or revision. Appropriate information and/or feedback is provided to the retailer 12. The retailer 12 may then sends inventory data, such as but not limited to purchase orders and the like, to the plurality of suppliers 20. The plurality of suppliers 20 then sends inventory to the retailer 12.

Accordingly, a retail establishment may be enabled to order and reorder inventory based on a much more complete understanding of the inventory and merchandising position and mechanics of the particular retailer. Further, such a system permits a powerfully modular approach to integrating the system into a retailer's existing processes. More, such a system permits an evolving merchandising strategy wherein critical focus and analysis may shift from time to time as issues are resolved and new issues appear. Also, the system permits scaling as an enterprise grows and as analyst programming, techniques and skills improve.

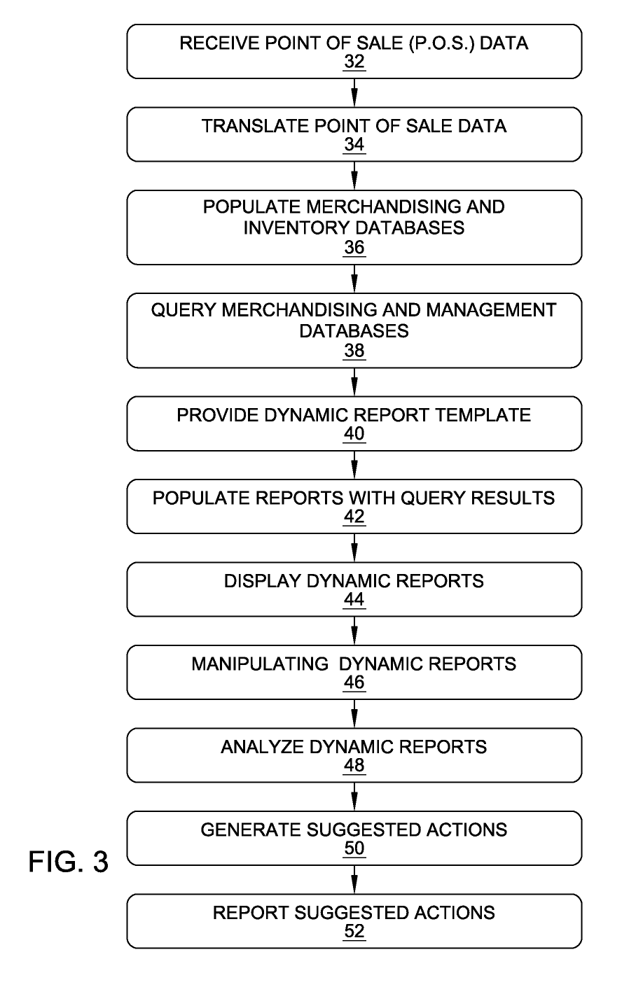

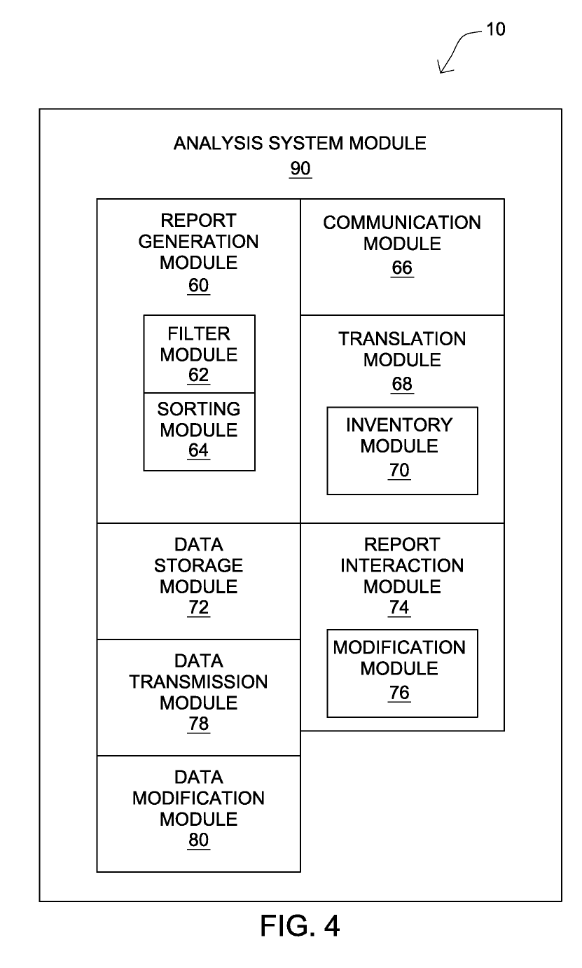

FIG. 3 is flow chart of a method of inventory analysis and merchandising, according to one embodiment of the invention. The method is configured to provide inventory management and merchandising data through machine processing of point-of-sale data from a remote retailer. The analysis method includes receiving point-of-sale data from a remote retailer over a network 32. This step additionally includes the step of receiving inventory data from a remote retailer over a network. The network determines translation requirements for the point-of-sale data and translates the sale data where appropriate 34. The analysis method then includes populating a data storage module with received point-of-sale data 36. Then, the analysis method includes querying the data storage module 38; wherein the analysis method includes generating a dynamic report template 40 and populating the template with the queried data 42. The dynamic report template includes user interactive tags, buttons, links, or the like (report interaction module or modification module, See FIG. 4) that are programmed to sort, filter, detail, edit, append, amend, or otherwise permit user to interact with the report view and/or the stored data. In one embodiment, the report interaction module includes instructions to resubmit a new query to the database and/or to generate a new view template for the queried data. In addition, this step may include the step of generating a report including inventory aging and sales information indexed together according to a common field.

The illustrated analysis method then includes displaying the dynamic reports 44. The dynamic reports are dynamically sortable, filterable, and selectably togglable in detailed levels. The method includes manipulating the dynamic reports 46. This may include sorting, filtering, amending, appending, or otherwise interacting with the data, reports, and/or views of such reports. Appended information may include suggested changes in inventory data (and potentially therefore in how the retailer handles the inventory, i.e. price, location, bundling, and the like). The dynamic reports may be filterable by a field selected from the group of fields consisting of vendor, product category, price, and store location. The dynamic reports are analyzed by an analyst 48; wherein the analyst generates suggested actions in regards to inventory management 50. This step also includes the step of altering inventory data and providing altered inventory data to a retailer; wherein the step of altering inventory data may include altering a price of a product and/or altering a category of a product. Moreover, the step of altering inventory data may include generating a composite product. Furthermore, the analysis method 30 includes reporting suggested actions to the remote retailer 52.

FIG. 4 is a module diagram of a system module of an inventory analysis and merchandising system, according to one embodiment of the invention. The analysis system 10 includes a system module 90 configured to send/receive information/data over a network. The system module 90 includes a report generation module 60; wherein the report generation module 60 is configured to generate dynamic reports therefrom. The report generation module may include a user interface application/module configured to interact with a data storage module 72 such as but not limited to a database system such as but not limited to SQL by Microsoft Corp. and/or Oracle Database by Oracle Corporation. Such user interface modules are plethoric and available from many sources, including but not limited to PeopleSoft by Oracle Corporation and Infopath by Microsoft Corp. The illustrated report generation module 60 includes a filter module 62, wherein the filter module 62 is configured to filter data to a desired format. The illustrated report generation module 60 also includes a sorting module 64. The sorting module 64 is configured to sort data to a desired format. In addition, the filter module 62 and the sorting module 64 may be used in combination with one another or separately to organize data to a desired format. There may also be other modules configured to otherwise manipulate reports, views, underlying data, and/or associated data.

The illustrated system module 90 also includes communication module 66; wherein the communication module 66 is configured to provide communication over a network. The communication module 66 may be configured to connect wirelessly with a network. The system module 90 also includes a translation module 68 in communication with the network and configured to translate data to a desired format. The illustrated translation module 68 includes an inventory module 70, wherein the inventory module 70 is configured to collect data from a retailer. The translation module 68 is in communication with a point-of-sale device of a retailer, wherein the translation module 68 receives data directly from the point-of-sale device of the retailer.

The illustrated system module 90 further includes a data storage module 72 in communication with the network and configured to store data in a desired format. In addition, the system module 90 includes a report interaction module 74 in communication with the report generation module 60 and configured to facilitate dynamic modification of reports. The report interaction module 74 includes a modification module 76, wherein the modification module 76 is configured to modify dynamic reports. Such may include but is not limited to filtering, sorting, merging, and splitting tables, forms, rows, columns, records, fields, etc. Furthermore, the system module 90 includes a data modification module 80 in communication with the report interaction module 74 and configured to alter data stored in the data storage module 72. The system module 90 includes a data transmission module 78 in communication with the network and configured to provide data over the network.

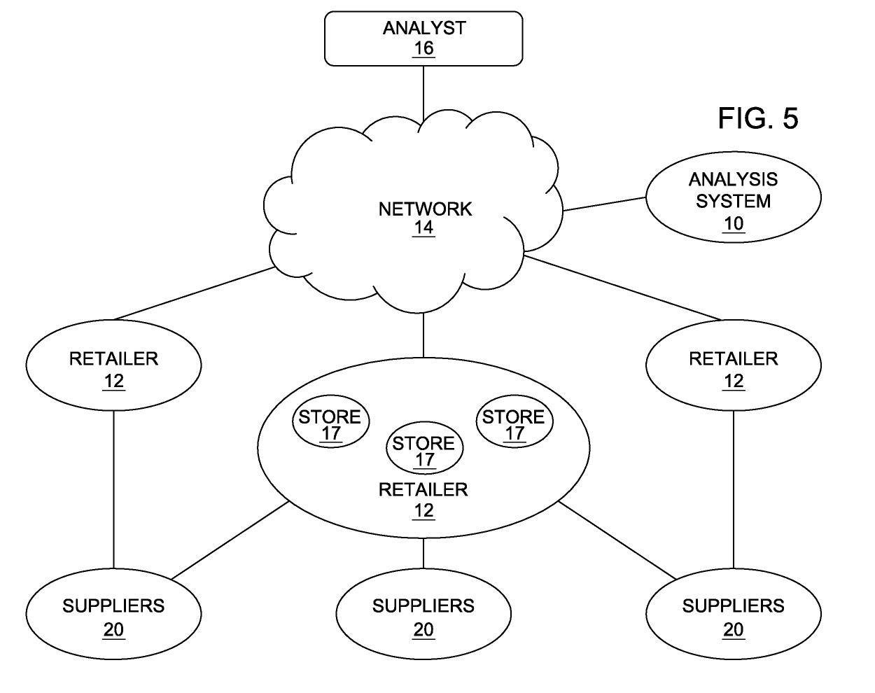

FIG. 5 is a network diagram of an analysis system 10, according to one embodiment of the invention. The analysis system 10 includes a plurality of retailers 12. The plurality of retailers 12 are in various states of communication with a plurality of suppliers 20. The plurality of retailers 12 receive inventory from the plurality of suppliers receives monetary funds in exchange for the inventory. The analysis system 10 is in communication with a network 14 and the retailer 12 sends data through the network 14 to the analysis system 10 and thereby to the analyst 16. The system 10 generates the dynamic reports and sends inventory management data to the analyst 16 for review, revision, and comment for the benefit of one or more of a plurality of retailers 12 in regards to inventory from the plurality of suppliers 20. As illustrated, a retailer 12 includes a plurality of retail stores 17 managed by the retailer 12, and configured to operate with the analyst 16 of the analysis system 10. One or more retailers or retail groups may participate to varying degrees in such a system, including but not limited to providing information and receiving feedback. Such information may be passed along raw or in a processed form to one or more suppliers.

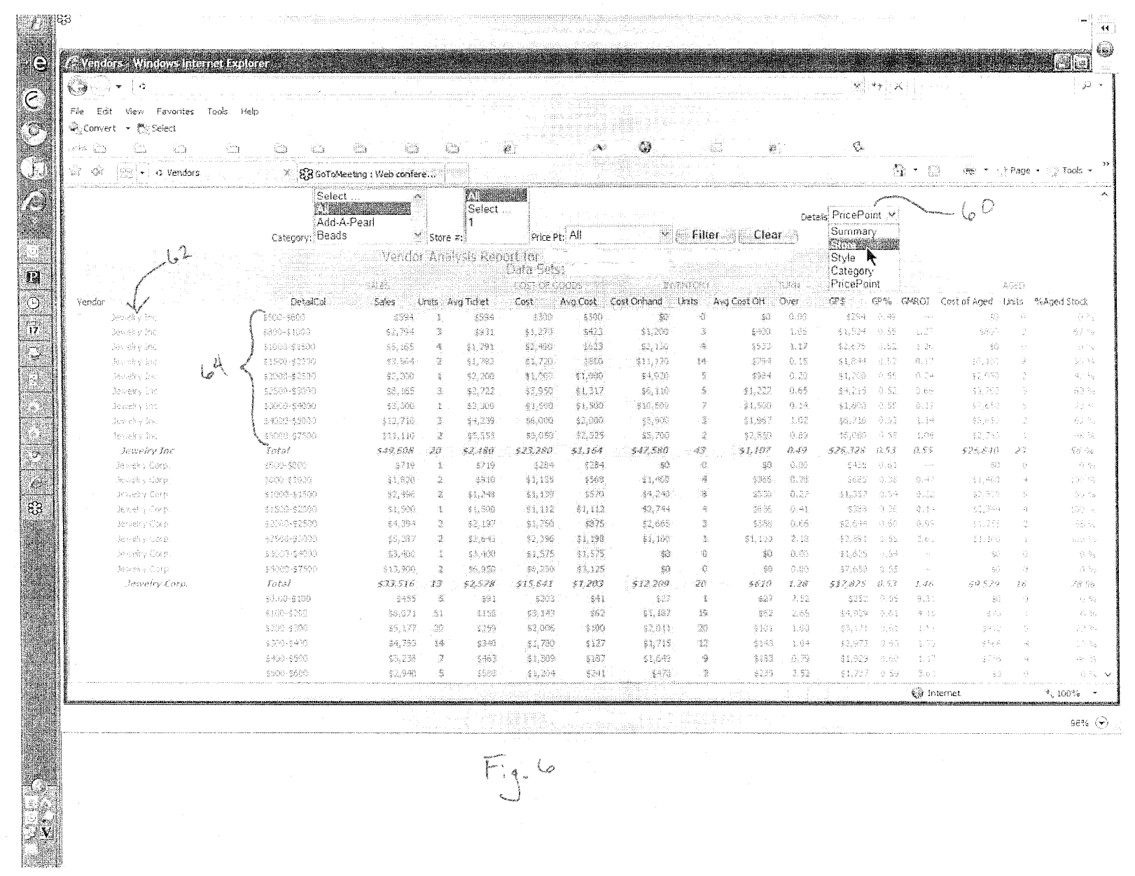

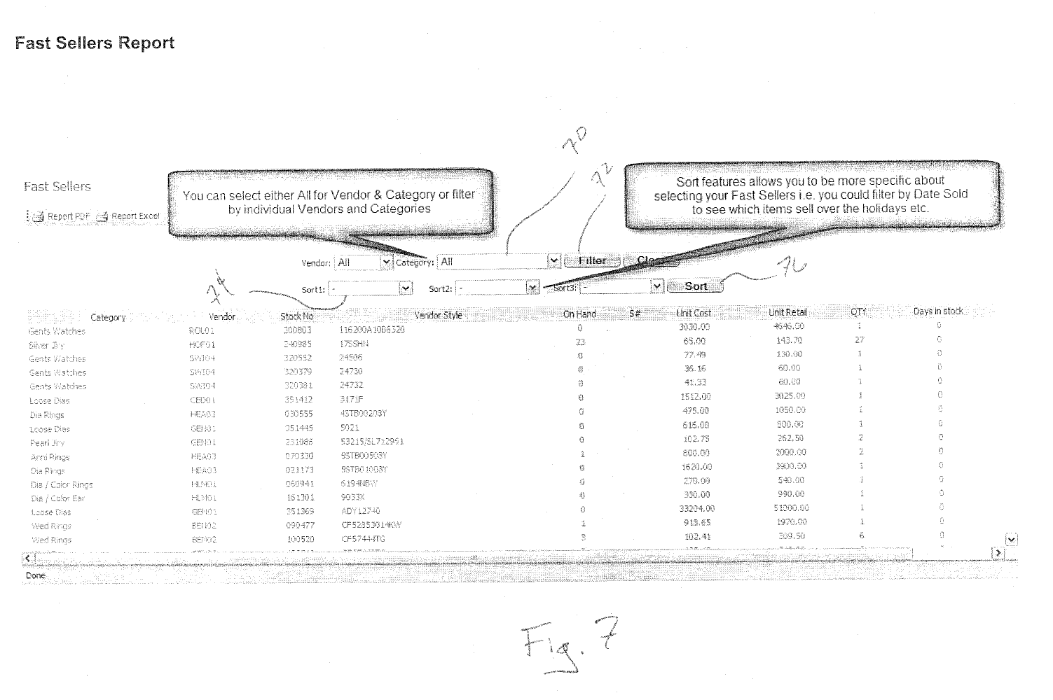

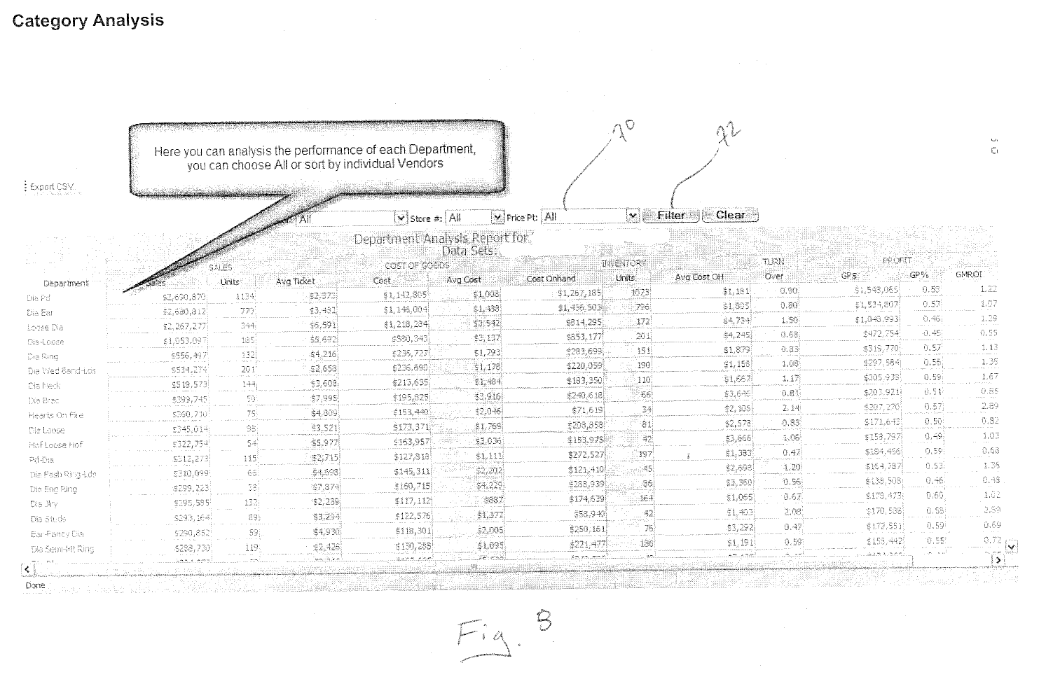

FIGS. 6-8 illustrate screenshots of a dynamic report of an inventory analysis and merchandising system, according to one embodiment of the invention. In particular, there is a drop down box 60 shown with a plurality of detail categories, wherein the category of Price Point controls the current view. Accordingly, there is an additional field named DetailCol having a plurality of subcategories 64 related to Price Point that break up information from single vendors 62. Activation of a detail category may generate a new report view including the associated meta-field and displaying the data according to a preprogrammed protocol configured to separate data record collections into groups according to the detail category. Accordingly, a user may be able to obtain a greater degree of information about inventory and merchandising for a retailer than what otherwise would be available.

There is also shown a filtering drop down box 70 whereby a user may select a filtering category whereby to exclude data records from the report. Filtering (and thereby generation of a new view) may be executed by activation of a button 72. There is also shown a sorting drop down box 74 and a sort button 76 that operate similarly.

The system described herein provides many advantages to retailers and analysts. One of the issues in reporting data across many retailers is that the data is not normalized for the key fields across which the reporting is done. For example, supplier information may be recorded differently by retailers into their point-of-sale systems. Each retailer has a Supplier Table that translates Vendor Codes into Vendor Names. Several variations of names for the same vendor appear throughout the database. One embodiment of the described analysis system allows a master table to be created that cross-references suppliers across different retailers. A dataset may be created which contains all relevant records in the database pertaining to a particular supplier to be gathered into a single dataset. This may allow a supplier to perform in-depth analysis of the performance of their goods in all the stores that participate in the analysis system.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a retailer sending data to the analysis system though a network, one skilled in the art would appreciate that the analysis system may be configured to automatically receive data from the point-of-sale device of the retailer, through the network, when the retail customer purchases goods/services; so the analysis system may be continuously updating and providing the most accurate and real time advice.

Additionally, although the illustrated figures include a dynamic report, one skilled in the art would appreciate that the analysis system may provide a plurality of dynamic reports and/or other reports, tools, and information configured to facilitate data analysis. The dynamic reports may include reports regarding sales volume, gross profit, gross margin, return on investment, product display space, total revenue, total overhead costs, projected sales, projected returns, projected loss, item numbers, vendor names, vendor styles, days in store, total cost, final price, suggested price, and etc.

It is envisioned that the analysis system may include a Purchase Order module. A click-through of desired inventory may create a purchase order that may be able to be emailed or otherwise communicated directly from analysis system to the supplier for the retailer. Also, purchase orders may be programmed so that certain items are reordered automatically at specified intervals, based on feedback from the system or analyst, or at certain stock levels. Other purchase orders may be automatically created according to certain criteria occurring in the data, such as, but not limited to reordering of fast-sellers and never-outs.

It is also envisioned that product images may be included in data records. This may allow the user/analyst to view sales and inventory by looking at images of the merchandise, rather than simply a list of style or SKU numbers. The ability to view sales and inventory visually may be a valuable additional component of the merchandising process. The functionality may be refined so that a certain image may be used as a prototype for a number of variations including different metals, colors, and stones.

It is further envisioned that users may choose to include memo items (inventory on hand but not owned) and special order items in the datasets they send for upload. The status field may be expanded to identify these items in the dataset, and functionality may be added to the screens to optionally allow this data to be displayed or suppressed. If displayed, different colors may be used to differentiate this data from the normal asset inventory.

It is expected that additional reports may be created that display top-selling or fast selling merchandise for different vendors or suppliers, different categories, and different price-points, and in different regions of the country. Other reports may show items or categories or vendors that are selling well in certain parts of the country, but are struggling in other parts.

It is also expected that data may be uploaded into the analysis system at different times by different retailers. Additional reports and analysis may be programmed that may allow the comparisons of two different datasets representing different time periods. This may allow a user to monitor their progress over time and also test the efficacy of the system.

Finally, one skilled in the art would appreciate that the analysis system enables users to create a buying plan and budget, by category, that details the desired number of items by price point, the recommended SKU's based on fast-seller results, and the desired gross profit and cost range for each price point.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of providing inventory management and merchandising analysis through machine processing of point-of-sale data from a remote retailer, comprising:
a) receiving point-of-sale data from a remote retailer over a network;
b) determining translation requirements for the point-of-sale data and translating where appropriate;
c) populating a data storage module with received point-of-sale data;
d) querying the data storage module;
e) generating a dynamic report template displaying queried data;
f) revising an manipulating the dynamic report according to a protocol;
e) determining feedback; and
f) reporting feedback to the remote retailer.

2. The method of claim 1, further comprising the step of receiving inventory data from a remote retailer over a network.

3. The method of claim 2, wherein the step of generating a dynamic report includes generating a report including inventory aging and sales information indexed together according to a common field.

4. The method of claim 3, wherein the dynamic report is dynamically sortable.

5. The method of claim 4, wherein the dynamic report is filterable.

6. The method of claim 5, wherein a detail level of the dynamic report is selectably togglable.

7. The method of claim 6, wherein the dynamic report is filterable by a field selected from the group of fields consisting of vendor, product category, and store location.

8. The method of claim 7, further comprising the step of altering inventory data and providing altered inventory data to a retailer.

9. The method of claim 8, wherein the step of altering inventory data includes altering a price of a product.

10. The method of claim 8, wherein the step of altering inventory data includes generating a composite product.

11. The method of claim 8, wherein the step of altering inventory data includes altering a category of a product.

12. The method of claim 8, wherein the dynamic report is sortable by price.

13. A analysis system for providing remote updated inventory management and merchandising data to a retailer, comprising:
a network module configured to receive information over a network;
a translation module in communication with the network module and configured to translate data to a desired format;
a data storage module in communication with the network module and configured to store data in a desired format;
a report generation module in communication with the data storage module and configured to generate dynamic reports therefrom;
a report interaction module in communication with the report generation module and configured to facilitate dynamic modification of reports;
a data modification module in communication with the report interaction module and configured to alter data stored in the data storage module; and
a data transmission module in communication with the network module and configured to provide data over a network.

14. The analysis system of claim 13, wherein the network module includes a communication module configured to provide wireless communication over the network.

15. The analysis system of claim 13, wherein the report generation module further comprises a filter module; wherein the filter module is configured to filter data to a desired format.

16. The analysis system of claim 13, wherein the report generation module further comprises a sorting module; wherein the sorting module is configured to sort data to a desired format.

17. The analysis system of claim 13, wherein the report interaction module further comprises a modification module; wherein the modification module is configured to modify dynamic reports.

18. The analysis system of claim 13, wherein the translation module further comprises an inventory module; wherein the inventory module is configured to collect data from a retailer.

19. The analysis system of claim 13, wherein the translation module is in communication with a point-of-sale device of a retailer, wherein the translation module receives data directly from the point-of-sale device of the retailer.

20. A analysis system for providing remote updated inventory management and merchandising data to a retailer, comprising:
a network module configured to receive information over a network; wherein the network module includes a communication module configured to provide wireless communication over the network;
a translation module in communication with the network module and configured to translate data to a desired format; wherein the translation module further comprises an inventory module; wherein the inventory module is configured to collect data from a retailer; wherein the translation module is in communication with a point-of-sale device of a retailer, wherein the translation module receives data directly from the point-of-sale device of the retailer;
a data storage module in communication with the network module and configured to store data in a desired format;
a report generation module in communication with the data storage module and configured to generate dynamic reports therefrom; wherein the report generation module further comprises a filter module; wherein the filter module is configured to filter data to a desired format; wherein the report generation module further comprises a sorting module; wherein the sorting module is configured to sort data to a desired format;
a report interaction module in communication with the report generation module and configured to facilitate dynamic modification of reports; wherein the report interaction module further comprises a modification module; wherein the modification module is configured to modify dynamic reports;
a data modification module in communication with the report interaction module and configured to alter data stored in the data storage module; and
a data transmission module in communication with the network module and configured to provide data over a network.
